(19) United States
(12) Patent Application Publication
(10) Pub. No.: US 2008/0046947 A1
(43) Pub. Date: Feb. 21, 2008

(54) Digital Media Server for Multiple Digital Tv Appliances Utilizing Native Signals Carried on Coaxial Home Wiring Networks

(76) Inventor: Ron D. Katznelson, San Diego, CA (US)

Correspondence Address: NATH & ASSOCIATES, 112 South West Street, Alexandria, VA, 22314, US

(21) Appl. No.: 10/556,090

(22) PCT Filed: May 10, 2004
(86) PCT No.: PCT/US04/14514

§ 371 Date: Apr. 19, 2007

Related U.S. Application Data
(60) Provisional application No. 60/469,573, filed on May 9, 2003.
(60) Provisional application No. 60/469,801, filed on May 10, 2003.

(51) Int. Cl. H04N 7/173

(52) U.S. Cl. 725/114

(57) ABSTRACT

A method for providing television services from a head-end to subscriber premises and includes receiving by a first subscriber terminal via a first transmission link coupled to the first subscriber terminal, a first television service transmitted from the head-end. System information data specifying attributes of at least one local television channel is transmitted to a second subscriber terminal coupled to the first subscriber terminal via a second transmission link. The at least one local television channel has a frequency that is unused on the first transmission link by the head-end. The first television service is transmitted by the first subscriber terminal, on one of the at least one local television channel via the second transmission link, to the second subscriber terminal located at the subscriber premises.

### CROSS-REFERENCE TO RELATED PATENT APPLICATIONS

The present application claims the priority of copending U.S. provisional applications having Ser. Nos.: 60/469,573 and 60/469,801, which were filed on May 9, 2003 and May 10, 2003 respectively, and are assigned to a common assignee.

### FIELD OF THE INVENTION

This invention relates in general to broadband communications systems, and more particularly, to the field of home video storage and server terminals and a networked multimedia system.

### BACKGROUND OF THE INVENTION

The advent of hard disk based digital media recorders (often called Digital Video Recorders or Personal Video Recorders “PVR”), have spurred adoption of these devices by consumers who wish to have more control over their television viewing and/or music listening experience. These media storage and playback devices permit users not only to time shift programming but they can also perform simultaneous recording and playback of television signals. These devices gives the viewer the compelling ability to “pause” a live television program, as well as various other “VCR-like” modes such as rewind, fast forward or slow motion. In addition, these devices allow the viewer to store programs and play them back at any time, even while recording a different “live” program. The full PVR experience is often completed by a service that maintains a continuously updated database in the recorder containing rich information about television programs. The recorder uses this database to allow the viewer to easily choose programs for recording and playback, or to easily navigate the live programming choices available. A technical description of how these PVR functions are implemented can be found, in part, in U.S. Pat. No. 6,233,389 to Barton, et al. issued on May 15, 2001 entitled “Multimedia time warping system”. In these PVR applications, as much as 100 hours of television programming may be stored on the PVR's hard disk owing to the powerful MPEG digital compression that is now available at low cost. Thus, ignoring for the moment the details of the subscriber interface and the storage and retrieval management, standard analog television signals are decoded, digitized and digitally compressed prior to storage and upon playback (retrieval from hard disk memory), the compressed MPEG streams are decompressed, re-encoded and converted by means of Digital-to-Analog Converters (“DAC”) into standard television signals for display on standard television sets and/or audio entertainment systems.

Many of the aforementioned processing steps may be eliminated within the PVR device when the program signals are already in digital MPEG format and a digital receiver (set-top or television) is appropriately connected to the PVR. In this case, the decoding, digitizing and MPEG compression steps prior to storage are not required since they are done at the digital signal origination site (at a broadcast station, the cable head-end or satellite uplink facility), and the MPEG decompression, encoding and DACs may be eliminated as these steps are implemented in the digital set-top. Such signal flow can be found in a system described in U.S. Pat. No. 6,442,328 to Elliott, et al., wherein advantage may be taken of the capability of the companion digital set-top to implement many of the signal processing functions and wherein the PVR may be used merely to handle the storage and retrieval functions. These types of systems permit the implementation of lower cost integrated digital set-tops and PVRs or PVR companions to digital set-tops. Vendors of digital set-tops for cable systems and for the satellite Direct Broadcasting Service systems (“DBS”) have recently introduced such integrated PVR set-top devices.

Unfortunately, the integrated digital set-top-PVR devices described above are not effective in serving multiple receiving outlets within the home, as they operate with a built-in digital set-top device which can provide one program signal to the television set it is connected to. Hence, for these devices, the stored programming available on the PVR and the interactive program guide it provides may not be viewed from multiple TV outlets in the home. In an attempt to solve this multiple outlet usage problem, vendors of PVRs have provided ancillary means for communicating digital media streams from the PVR to multiple TV sets by the use of home network devices such as those available under the IEEE 802.11 wireless LAN standards. However, this solution necessarily requires that each TV set be equipped with a “thin client” module including a network interface card, an MPEG decompression circuit followed by video encoding and DAC circuits in order to generate standard video and audio signals required by the additional outlets. Even if such additional outlets were to be served by digital set-tops, the latter's internal circuits for MPEG decompression, encoding and DACs cannot be accessed by home network devices since, for the most part, they are not designed to receive MPEG inputs from a network interface connector (and may not even have any such baseband digital input capability). Thus, most of the installed base of digital set-tops numbering in the tens of millions, cannot be taken advantage of by using the prior art PVR home servers. Furthermore, even new digital television sets that are introduced to market today do not have the appropriate network interface card or a baseband digital MPEG input capability that might enable the exploitation of their internal digital signal processing and encoding by PVR home servers of the prior art construction. Thus, there is a need for a digital media single server solution that can economically serve multiple legacy digital set-tops and digital TV (“DTV”) appliances without recourse to the installation of additional home networking equipment at each served outlet.

In view the above, it is the object of the instant invention to provide an economic solution and method for the construction of a single digital media server that can serve all television outlets that are equipped with digital set-tops or DTV devices without ancillary home networking equipment. It is a further object of the invention to provide such digital media server systems in a manner that utilizes the built-in capabilities of the installed base of digital set-tops and DTV appliances to enable through them the subscriber interaction, recording and playback of digital media on such servers. It is yet another object of this invention to provide a novel class of digital media server systems employing existing coaxial home wiring while distributing thereon signals that are native to, and receivable by, the existing digital set-tops and DTV appliances. Still another object of this invention is to provide digital media server systems for subscriber use that take advantage of head-end installed and coordinated application modules, enabling a hybrid PVR service at lower cost by combining local home PVR server and network (head-end based) PVR server in seamless manner. Other objects of the instant invention would become clear from the further disclosure as detailed in the specification and figures below.

Because most legacy and installed digital set-top and DTV devices cannot process digital MPEG signals other than those that are already RF modulated and are fed via their built in tuner-receivers, the instant invention relies on utilizing the native signal formats that are receivable by such digital set-tops and DTV appliances. These native formats are Quadrature Amplitude Modulation (“QAM”) for cable systems, Vestigial Side-Band (“VSB”) for terrestrial broadcast systems, and Quadrature Phase Shift Keying (“QPSK”) modulation in DBS systems. Furthermore, since these installed digital devices are connected to, and are fed via, the coaxial home wiring and since it is desirable to introduce no RF switches or new wiring, the signals emanating from the digital media server are modulated on an appropriate RF frequency and are injected into the coaxial home wiring network for reception by all relevant digital appliances connected to such home coaxial network. Part of the novelty of the instant invention is the specific method and manner in which signals from the program provider and from the local media server are coordinated, combined and are made to appear somewhat indistinguishable by the digital appliances. Another novel aspect of the invention is its use of the existing upstream transmission capability of two-way capable digital set-tops to interact not only with the cable head-end as originally intended, but also with the local digital media server in a manner that is coordinated with other two way interactive services offered from the cable head-end.

### BRIEF DESCRIPTION OF THE DRAWINGS

The invention can be better understood with reference to the following drawings. In the drawings, like reference numerals designate corresponding parts throughout the several views.

FIG. 1 depict the first preferred embodiment of the invention including channel lineup, subscriber gateway and the home digital media server in accordance with the invention.

FIG. 2 shows the signal and data flow diagram of the preferred embodiment of FIG. 1.

FIG. 3 illustrates the second preferred embodiment of the invention including channel lineup, subscriber terminal and the home digital media server in accordance with the invention

FIG. 4 shows the signal and data flow diagram of the preferred embodiment of FIG. 3.

FIG. 5 illustrates a third preferred embodiment of the invention including channel lineup, subscriber terminal and the home digital media server in accordance with the invention

FIG. 6 shows the signal and data flow diagram of the preferred embodiment of FIG. 5.

### DETAILED DESCRIPTION OF THE PREFERRED EMBODIMENTS

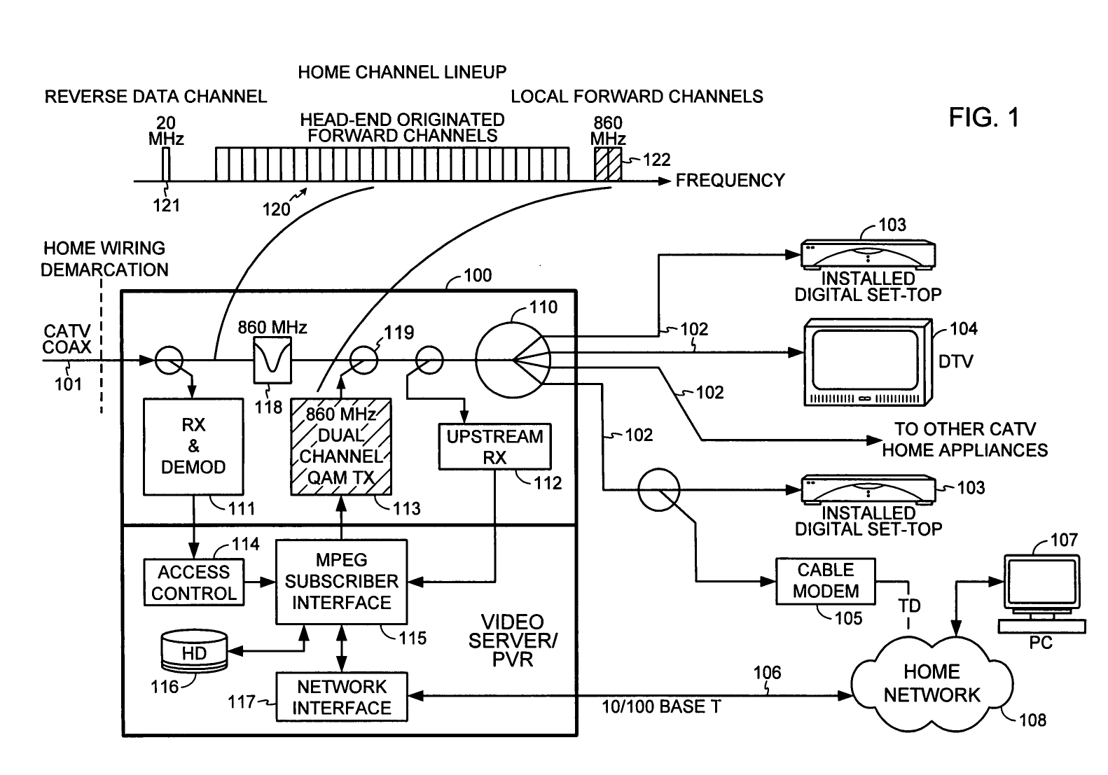

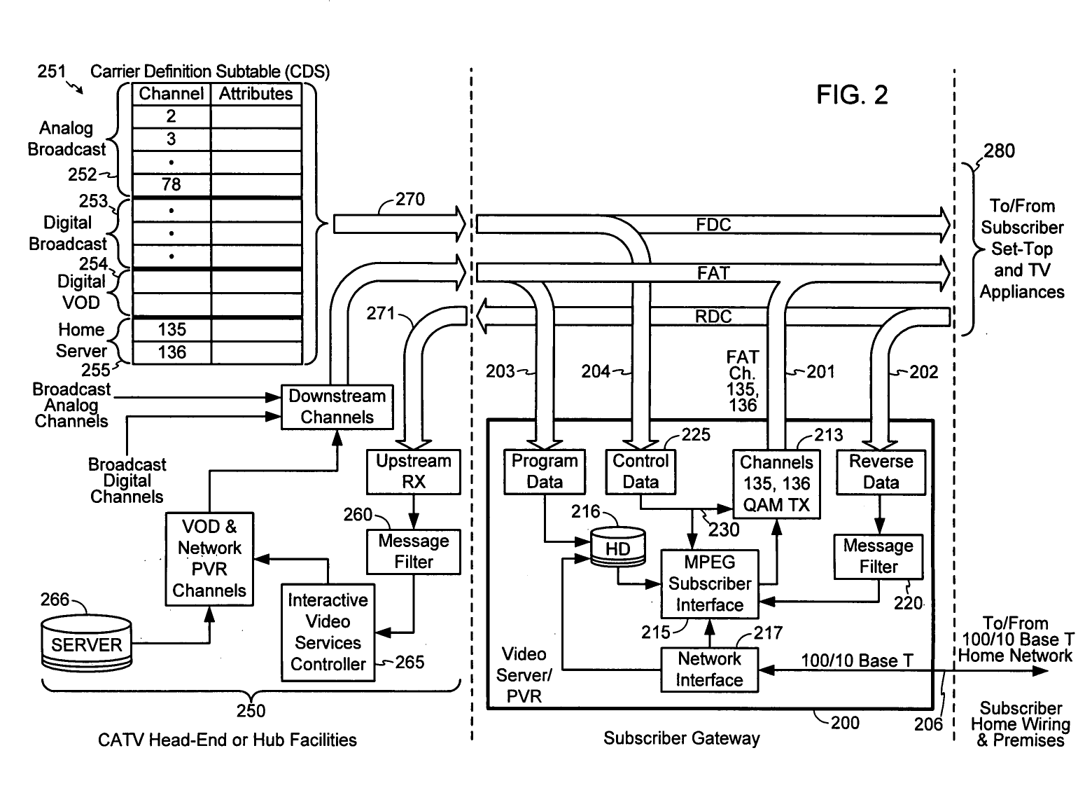

FIGS. 1 and 2 depict the first preferred embodiment of the invention, wherein it is assumed that the cable head-end operation is in full cooperation with that of the home digital media server. Referring to FIG. 1, the digital media PVR server 100 is shown embodied in a point of entry gateway device receiving a broadband RF signal from the cable plant at terminal 101 and distributing it to the whole house by means of a four-way splitter 110 that provides the signals on home coax wiring lines 102 to the various outlets that are terminated by installed digital set-tops 103, digital TV 104 and cable modem 105 and other CATV home appliances (if any).

The subscriber appliances connected to lines 102 in FIG. 1 can receive all downstream signals (Forward Channels) originating from the head-end. These are schematically shown as spectrum item 120 in the Home Channel Lineup diagram of FIG. 1. Furthermore, upstream signals from cable modem 105 and one or more of the (two-way) digital set-tops 103 are located in the upstream frequency band of 5 MHz to 45 MHz band and are passing through the passive structures in gateway server 100 from lines 102 via input terminal 101 up the cable plant to a central concentration facility at the cable head-end. As an example, a 20 MHz upstream signal from one of the digital set tops 103 is schematically shown being transmitted upstream as spectrum item 121 in the Home Channel Lineup diagram. This upstream signal can be received by the cable head-end upstream receiver for head-end based processing and as can be seen in FIG. 1, a tapped sample of it can also be received by the server's upstream receiver 112.

Still referring to FIG. 1, the server's receiver and demodulator 111 can receive any of the programming signals that are transmitted downstream in the forward channels. It may contain dual receiver structures for receiving multiple channels simultaneously and it also contains the Forward Data Channel (“TDC”) receiver that receives control data and access control entitlement messages in a manner similar to that used by digital set-top devices known in the art. Similarly, the PVR reception, storage and retrieval functions known in the art can be implemented for signals at the output of the access control unit 114 by the MPEG subscriber interface unit 115 in conjunction with hard disk drive 116, in response to subscriber commands received at 115 from the upstream receiver 112. As will be further detailed, these subscriber commands arrive from the upstream transmitter of the two-way set-top 103 in response to the subscriber interaction via his remote control with various On-Screen Display menus shown on the TV connected to the set-top (not shown in the figure). It becomes clear that with the exception of the subscriber command interface and the mode for programming playback, the PVR server system as described essentially operates as an integrated set-top PVR device. Viewing of the PVR output and playback is achieved by routing one or two digital signals to a QAM RF modulator 113 from the MPEG processor in 115. The preferred embodiment shows a dual QAM channel transmission device for 113 in order to accommodate multiple HDTV streams, although one can easily use a single digital QAM channel transmitter, as it can carry many standard definition video streams simultaneously. The QAM RF modulator 113 coupled via directional coupler 119 to the main line can be configured to tune over the upper cable band that might be unused by the downstream channel lineup. Typically, the top of the band around 860 MHz may be unused by the cable system but within the tuning range of all digital set-tops, thereby making it a compatible choice. Thus, subject to appropriate channel definition and configuration of the set-top (as described below), it can tune to receive any of the digital streams provided by the PVR server 100 on the QAM channels situated around 860 MHz and shown schematically as spectral item 122 on the Home Channel Lineup diagram of FIG. 1. Importantly, these channels may be received by any of the CATV home appliance devices connected to lines 102, thus providing the important multiple outlet feature of the present invention. A band reject filter trap 118 is preferably field configurable to match the frequency available for PVR originated QAM channel frequencies that do not conflict with the cable channel lineup, which in this case, is 860 MHz. This band reject filter, (two channel wide) serves two purposes. The first, is to remove any noise or interference arriving on 860 MHz from the cable system (or a neighboring subscriber) on terminal 101 so that it would not degrade the reception by the set-tops 103 or DTV 104 of the local QAM channels; The second is to provide filtering of any locally generated 860 MHz QAM signal reflected back from splitter 110 via directional coupler 119 back in the upstream direction. This helps protect neighboring subscribers who might have their own PVR locally generated QAM channels on the same frequency. An important feature that trap 118 should have must not be overlooked: It must exhibit a flat (uniform) reflection characteristics over its rejection frequency band covering the two channels so as to minimize frequency response and group delay distortions as seen at the output of directional coupler 119.

FIG. 1 also shows that via network interface unit 117, an optional Ethernet 10/100 Base T home network connection 106 can be made to home PC 107 through the home network 108, which may include a router. This connection beneficially enables one to download various media files other than those received by receiver demodulator 111 to the PVR server. It also permits another mode of subscriber interaction with the PVR server by the use of PC based applications. Organization of media directories and play-lists can be thus achieved while permitting simple and rudimentary interactions with the set-top OSD function.

FIG. 2 shows the signal and data flow diagram of the preferred embodiment of FIG. 1. As a data flow, it does not necessarily show the physical interconnection among components. We adopt herein the terminology and the functional descriptions of signal interfaces between cable systems and digital set-tops as described in Digital Cable Network Interface Standard published by the Society of Cable Telecommunications Engineers as document SCTE 40 2001 (Formerly DVS 313), which is incorporated herein by this reference and shall be referred to hereinafter as “DVS-313”. The functions within the PVR server are shown by unit 200. These functions are shown to be performed at the subscriber gateway. The signals that flow to (and from) the subscriber digital set-tops and TV appliance are shown at 280. These actually flow at RF frequencies on home wiring 102 of FIG. 1 and are shown to have three major components. The first is the Forward Application Transport (“FAT”) channels containing the media programming content delivered to the subscriber; The second is the Forward Data Channel (“FDC”) which conveys control data and system information used to receive and decode the content on the FAT. It is often carried on an Out-Of-Band channel, requiring a dedicated receiver and demodulator in the digital set-top. The third component is the Reverse Data Channel (“RDC”) which originates at the subscriber site and conveys upstream information from the digital set-top to the cable head-end for interactive services. The PVR Server of the first preferred embodiment passes through these signal components in their entirety from the cable head end or hub facility 250 to the subscriber set-tops at 280 and vice versa.

The operation of the Server PVR in accordance with the first preferred embodiment is based on a cooperative specific configuration of the cable head-end so as to enable the set-tops and DTV appliances to have the necessary system control information to (a) receive the locally inserted FAT channels at 201 and to (b) transmit upstream RDC information to be received by the Server PVR for subscriber interaction with the Server PVR. To accomplish that, the head-end or hub facility is configured to transmit additional system information packets on the FDC which defines the locally generated FAT channels in a manner that is applicable for all subscribers who have a Server PVR installed and are connected to that hub. This is done by augmenting the Program and System Information Protocol (“PSIP”) messages, as described below. PSIP messages used by the head-end are described in SCTE's DVS-234 standard entitled Service information Delivered out-of-band for Digital cable television, Revision dated 28 Mar., 2000, which is incorporated herein by this reference and referred to hereinafter as DVS 234. Referring to FIG. 2, the Carrier Definition Subtable 251 of the DVS-234 PSIP originating at the head-end on the FDC signal is shown to convey information on the physical channel frequencies and logical attributes of the analog service 252 (Channels 2-78), the digital broadcast service 253 (channels above 78) and the digital narrowcast Video On Demand (“VOD”) service 254 (below Channel 135). These services are all existing services that originate from the head-end or hub facility. For the benefit of home Server PVRs used by subscribers connected to this hub, additional PSIP packets are added to define the home server channels 255 (Channels 135,136) in accordance with DVS-234. An example for such augmentation packets based on Table 5.3 CDS record format for a two-channel group starting at 852 MHz is as follows:
Number_of_carriers=2
spacing_unit=1 (125 KHz, normal for Video)
frequency_spacing=48 (6 MHz/125 kHz, The distance between carriers)
frequency_unit=1 (125 kHz)
first_carrier_frequency=6816 (852 MHz*8, for 125 kHz steps)

Similarly, for some set-tops, PSIP transmission for similar FDC payload that can be sent in-band may be employing the Cable Virtual Channel Table (CVCT) structure of the PSIP in the A/65 ATSC standard entitled Program and System Information Protocol for Terrestrial Broadcast and Cable, which is incorporated herein by this reference.

Using downstream and upstream protocols such as ANSI/SCTE 55-1 2002 (formerly DVS 178) Digital Broadband Delivery System: Out Of Band Transport Part 1: Mode A or ANSI/SCTE 55-2 2002 (formerly DVS 167) Digital Broadband Delivery System: Out Of Band Transport Part 2: Mode B, which are both incorporated herein by this reference, via the FDC at 270 and the RDC at 271, the system at the head-end can configure the set-tops to enable their non-conflicting interaction with both the head-end and the Server PVR. This may be done by downloading to the set-tops new resident middleware application that is configured to handle two upstream receiving entities (the hub facility 250 and the Server PVR 200) and by proper use of the Medium Access Control (“MAC”) messaging to enable aternate upstream communications. Turning back to the Server PVR, additional FAT local channels (shown here as Channels 135 and 136 on 860 MHz) are inserted by the Server PVR at 201 and it receives the RDC signal component at 202. It also receives head-end originated FAT channels at 203, which it can store in the hard disk 216. In addition, it receives the FDC at 204, permitting it the usage of the relevant system information and access control messages. The PSIP information which identifies the home server payload 255 and received in control data processor 225 may be provided to the QAM channel transmitter 213 via line 230 to configure its operating frequency. Message filter 220 is configured to ignore all messages from the set-top that are destined to the head-end or hub site 250. Similarly, messages from the set-top destined to the Server PVR can be received at 202, recognized at message filter 220 and ignored at the head-end by the use of message filter 260. The above discrimination may be implemented by assigning via the MAC an otherwise unused 16 bit Return_Path_Id word to all upstream communications from the set-top to the Server PVR. Thus, message filters 220 and 260 would filter complementary sets of such Return_Path_Id based messages. That way, Set-top-Server PVR interaction sessions can be conducted while they are ignored by the head-end system. Similarly, Set-top VOD interaction sessions with the head-end can be ignored by the Server PVR device.

The User Graphic Interfac (“GUI”) screens that the Set-top uses to interact with the Server PVR can be downloaded from the head-end or hub site on the FDC or the FAT and stored in an appropriate application segment of the hard disk 216 and upon subsequent subscriber interaction sessions can be invoked into an MPEG stream by the MPEG subscriber interface processor 215 via transmitter 213 in one of the local FAT channels on 201 during the relevant session. Alternatively, the screens for such interaction can be provided by downloading through the local Ethernet home network port at 206.

In instances wherein the subscriber digital appliance used for viewing the digital media does not have upstream transmission capability (as may be the case in DTV sets), the Server PVR can still provide all the FAT channel services as described above while the augmented PSIP signals are still provided as described above, except that the interaction with the Server PVR for purposes of storage and playback may be achieved by the use of the home PC through the home network port 206.

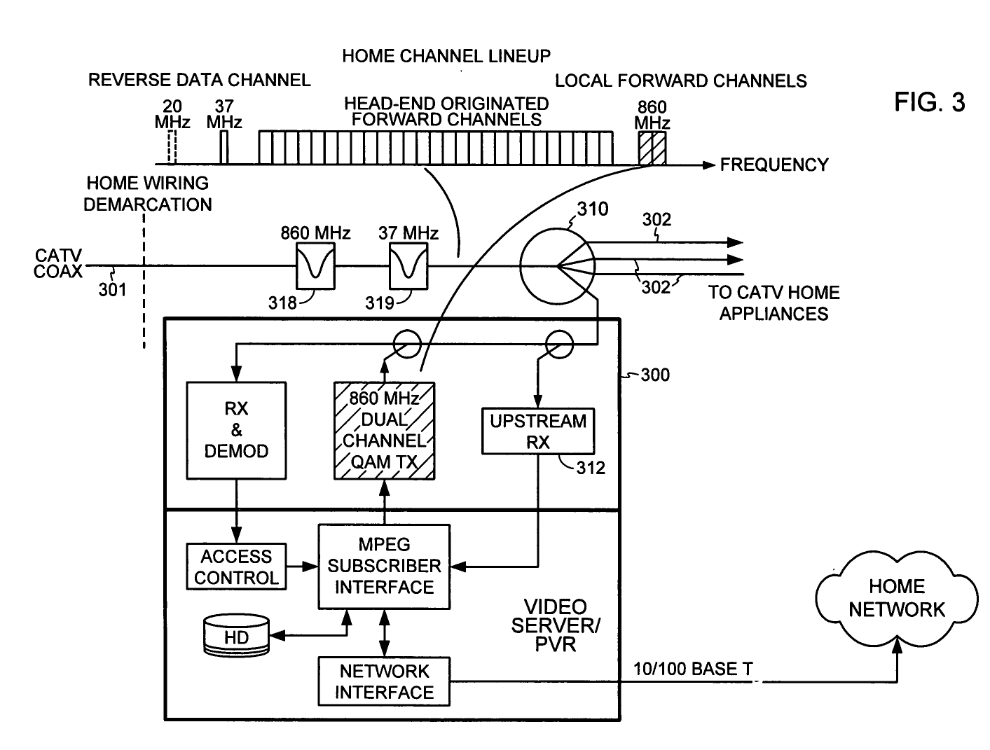

FIG. 3 shows a second preferred embodiment of the invention. For clarity, the home terminals and appliances are not shown. Unlike the gateway configuration of FIG. 1, this configuration permits the Server PVR to be installed at an outlet within the house after the four-way splitter 310. It may even be an integrated set-top -Server PVR serving one TV outlet (not shown). Here, field configurable trap 318 has the same technical requirements and serves the same functions as trap 118 of the first embodiment as described above but it also serves to reflect back into the home wiring lines 302 the 860 MHz signal from the Server PVR 300. In this second preferred embodiment, an upstream 37 MD trap 319 is shown as a signal blocker and reflector for return-path signals originating from two-way capable set-tops connected to any of the outlets on lines 302. Thus, upstream signals transmitted on 37 MHz by subscriber's set-tops are reflected back and received by the Upstream receiver 312 of the Server PVR. It on the other hand, the set-tops are configured to transmit their upstream signals on, say, 20 MHz, no reflection will occur and the signal will pass through upstream to the cable head-end or hub via terminal 301. This frequency directivity on the return path enables physical discrimination for upstream messages without having to implement logical message filtering as described in FIG. 2. Messages from set-tops that are destined to the Server PVR are transmitted on 37 MHz while messages destined to the head-end are transmitted on a frequency sufficiently different than 37 MHz, (20 MHz in this example) whereupon they pass through traps 319 and 318 via terminal 301 up the cable network. Of course, other frequency combinations between 5 Mz to 45 MHz for the two upstream communication links can be selected based on specific upstream spectrum availability.

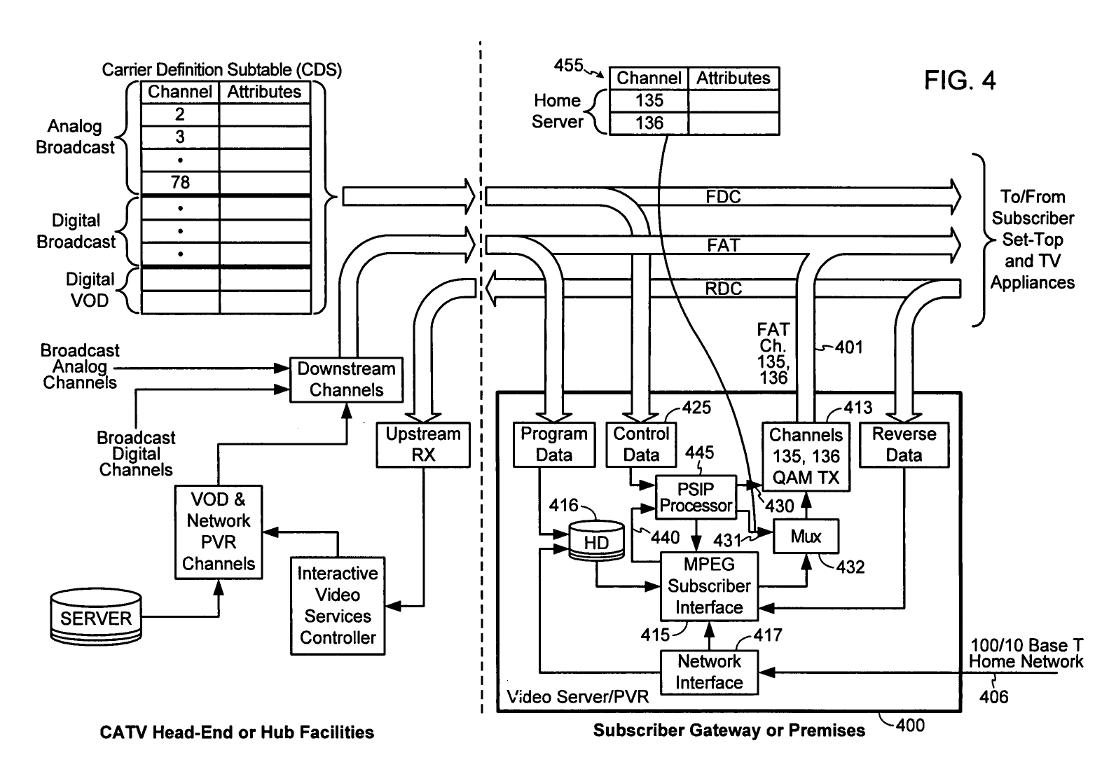

Unrelated to the upstream physical discrimination feature described above, the second preferred embodiment of the invention is configured to operate with set-tops that can receive and process control data information transmitted in-band. It is also assumed that such in-band control data transmission can be received by the set-tops on the locally inserted QAM channels 135 or 136, meaning that PSIP messages can be inserted locally by the Server PVR system in a way that does not conflict with those received from the head-end. FIG. 4 depicts the data flow corresponding to the second preferred embodiment of FIG. 3, showing the locally inserted PSIP messages containing the system information of the local channels and their attributes (455) and generated by the PSIP processor 445. These are fed in-band into the QAM channel via line 431 and Mux 432. The insertion of the requirement for the local FAT channels is provided by the MPEG subscriber interface 415 (optionally in response to commands from the home network line 406), which communicates with the PSIP processor 445 via data flow line 440. Because the PSIP processor also receives all head-end originated PSIP messages, it can then assign the appropriate non-conflicting PSIP attributes to the locally generated FAT channels provided on 401.

As in the first preferred embodiment, a resident middleware set-top application can be downloaded to the set-tops, either by way of head-end originated FDC messages or via the home network and the in-band control channel provided to Mux 432 (not shown), wherein such new set-top capability afforded by the middleware has the specific feature of using two different upstream frequencies for communicating with the Server PVR and the head-end. Subscriber interaction can then follow in a manner similar to that discussed in the first embodiment.

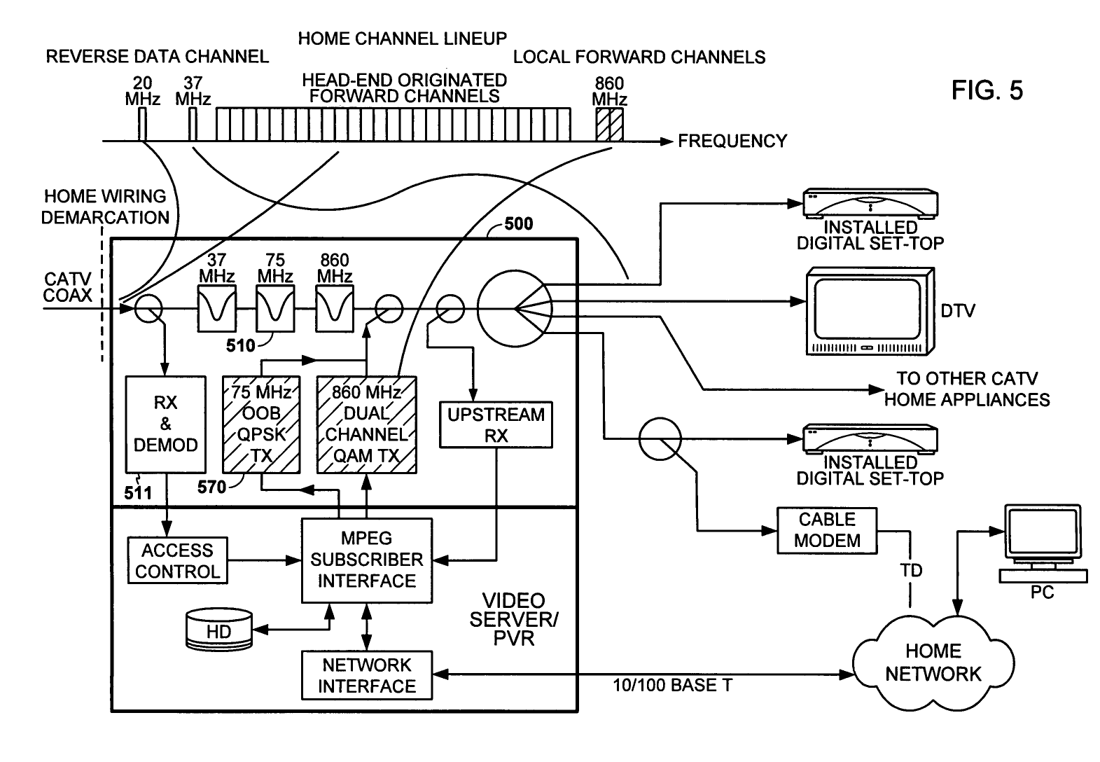

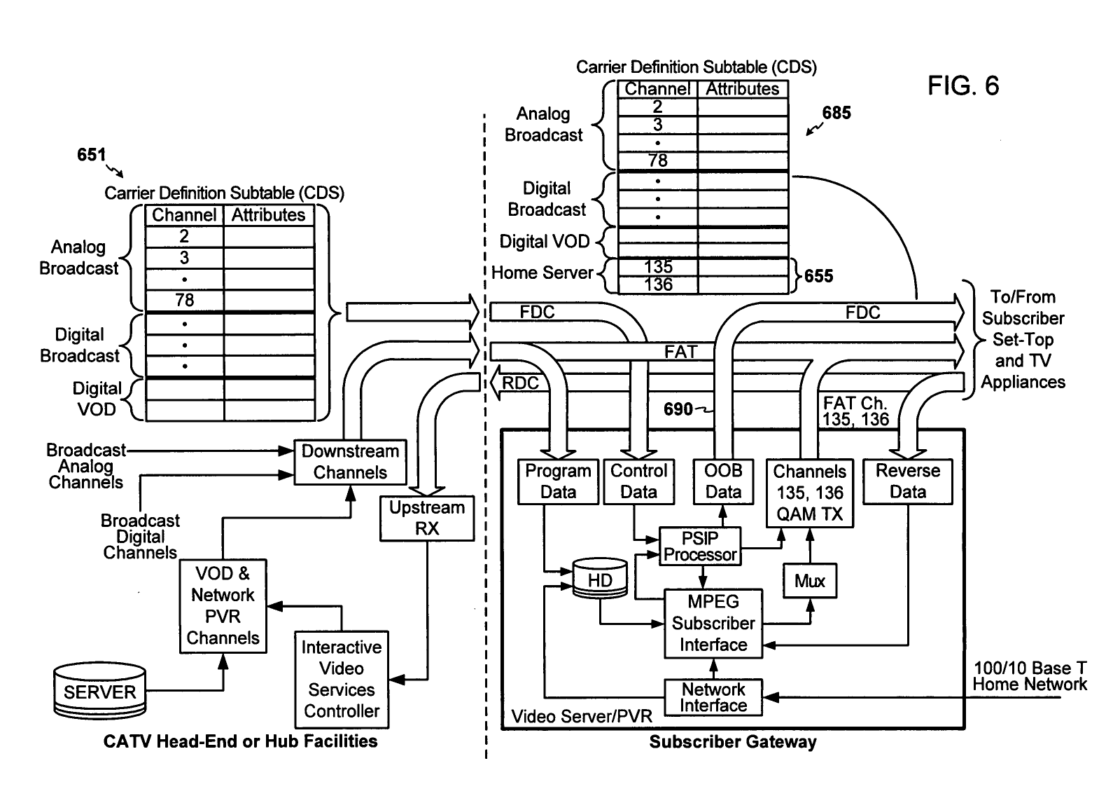

FIGS. 5 and 6 show yet a third preferred embodiment of the invention wherein no cable head-end coordination is required. In this example, the FDC is carried out-of-band on 75 MHz stream and that signal is not passed through to the subscriber set-tops. Rather, it is blocked by trap 510. However, the head-end originated control signal is received by an out-of-band (“OOB”) receiver within the receiver & demodulator unit 511 and the original PSIP payload 651 is appended by the locally inserted payload 655. It is subsequently inserted as the full PSIP payload 685 into a Server PVR originated OOB data stream transmitted by the 75 MHz OOB QPSK transmitter 570 into a new OOB FDC on 690.

The system in accordance with the third preferred embodiment can operate in all other respects in a manner similar to that disclosed for other embodiments. In all of the above embodiments, subscriber sessions which graphically convey the various program advisory materials within the PSIP can also be provided and stored on the hard disk within the Server PVR. It is the existing capability of the set-tops to present these that affords this invention an advantage, as these attributes can be retransmitted compatibly in the locally generated PSIP messages.

Finally, it should be appreciated that the specific embodiments described in the context of a cable system are not limited to such systems. According to the invention, a Server PVR of a similar construction can augment wireless MMDS or satellite DBS services. For example, in a DBS application, the embodiment of FIGS. 3 and 4 can be applied wherein the 860 MHz QAM transmitter is replaced by a QPSK transmitter tuned to an unused L band channel (between 950 MHz and 2 GHz) and the combined signal distributed within the home wiring. The Dish antenna and LNB downconverter would then be connected at terminal 301 and trap 318 would have the appropriate L band frequency.

What is claimed is:

1. A method for providing television services from a head-end to subscriber premises, comprising the steps of:
receiving by a first subscriber terminal via a first transmission link that is coupled to the first subscriber terminal, a first television service that was transmitted from the head-end; and
transmitting system information data specifying attributes of at least one local television channel to a second subscriber terminal coupled to the first subscriber terminal via a second transmission link, wherein the at least one local television channel has a frequency that is unused on the first transmission link by the head-end; and
transmitting the first television service by the first subscriber terminal, on one of the at least one local television channel via the second transmission link, to the second subscriber terminal that is located at the subscriber premises.
